(19) United States
(12) Patent Application Publication
(10) Pub. No.: US 2004/0244603 A1
(43) Pub. Date: Dec. 9, 2004

(54) Edible chocolate writer arrangement

(76) Inventor: Ronald Magers, Essex, MA (US)

Correspondence Address: Donald N. Halgren, 35 Central Street, Manchester, MA, 01944, US

(21) Appl. No.: 10/778,596

(22) Filed: Feb. 13, 2004

Related U.S. Application Data
(60) Provisional application No. 60/447,069, filed on Feb. 13, 2003.

(51) Int. Cl. A23L 1/00

(52) U.S. Cl. 99/353

(57) ABSTRACT

A hand manipulable apparatus for the receipt and extrusion of a stream of edible material. The apparatus includes an elongated housing having a first end and a second end with a discharge nozzle in the first end. A chamber is arranged within the first end of the elongated housing for receipt of a meltable edible material. A circuit is arranged in the first end of the elongated housing for heating and melting the edible material; and a chocolate advancer member such as a rotatable auger is arranged within the distal end of the housing for extrudably discharging the edible material out of the housing through the nozzle.

### BACKGROUND OF THE INVENTION

1. Field of the Invention

This invention relates to devices for melting and discharging edible food substances, and is based upon co-pending Provisional Application No. 60/447,069 filed 13 Feb. 2003, which is based upon Provisional Application No. 60/356,795, filed 14 Feb. 2002, each of which are incorporated herein by reference.

2. Prior Art

In the cooking field and particularly for bakers of cakes and cookies or the like, those products are decorated by a hand application of sugary fluid-like compounds of frosting or confectioner's material or the like. It is usually applied from a cloth baglike device having a nozzle at one end thereof. The bag-like container is filled with the edible paste to be applied to a surface, and the bag is wrung tightly by hand to apply pressure to the confectionary product inside of that bag. The product such as frosting or decorative confection then may be pushed out of the nozzle and on to the article to be decorated. Such a frosting or confectionary material has to be made in its fluid state and then stuffed into the bag-like container. Such loading of the “bag” is messy and not well suited for doing by young children. This work is tedious, and may be difficult for an older child to do this if one were utilizing this apparatus as an educational toy. There is no easy loading nor easy cleaning nor easy articulation by an adult, let alone a child.

It is an object of the present invention to provide an edible-confection applicator device which overcomes the disadvantages of the prior art.

It is a further object of the present invention to provide an edible-confection delivery apparatus which is safe to use even for a child, without an external components which might harm even a young child.

It is a further object of the present invention to provide an edible-confection distribution apparatus which is simple to operate and very easy to maintain, load, clean and use.

It is a further object of the present invention to provide a confection distribution apparatus which may be loaded with a “dry” confection to facilitate efficiency in its use.

It is a further object of the present invention to provide a confection distribution apparatus which is easily manipulated and utilized as an artistic appliance, held much like a brush or a pen.

### BRIEF SUMMARY OF THE INVENTION

The present invention comprises a unique, small diameter, hand held, readily manipulable confection applying device. The confection applying device comprises an elongated chamber or housing of generally cylindrical configuration having a lower or first confection-applying end and an upper or second chamber-loading and power-adaptive end.

The lower or first end has a replaceable fluid discharge nozzle thereon. The elongated chamber comprises a housing into which a rotatable auger is supported. The auger has a tipped or distalmost end which is in communication with the nozzle at the first end of the apparatus. The auger is arranged about a rotatable shaft having an upper or proximalmost end which engages a coupler.

The coupler arranged in the second or uppermost end of the elongated housing and is attached to a drive shaft. The drive shaft is arranged on the upper end of a reducing gear transmission arrangement. The transmission arrangement is attached to the output shaft of an electric motor arranged within the second or uppermost power adaptive end of the elongated housing. A power cord may be arranged through the uppermost end of the housing to a battery or power supply. A further aspect of the present invention preferably comprises a battery arranged within the second end of the housing.

The upper end of the confection applying device comprises an end housing which is separable from the main body portion of the confection applying device at an end-adjacent location where the rotatable shaft meets the transmission coupler.

A control switch is located adjacent to the lower or first end of the elongated housing. The control switch may include a rheostat having an electric circuit in communication with the electric motor to variable control the speed or direction of rotation of the output shaft of the motor and thereby control the speed or direction of rotation of the auger on the auger shaft.

A temperature control element may be arranged in a circuit adjacent the lower end of the elongated housing. The circuit may include an upper-temperature limitation arrangement therewith, so as to minimize the amount of heat which may be provided to the housing. The elongated housing comprises a chamber into which dry “chips” of confection material such as chocolate chips or other like-chip or dry, meltable granular material may be disposed when the upper end of the housing is removed from that main housing portion thereof.

Thus a baker or cook or even a child may apply an edible confection of granular material within the housing of the elongated housing member when the upper end cap is removed. Actuation of the on/off control switch may actuate the heating element (and/or a cooling chamber) to provide a minimal temperature sufficient to melt the confection material within the lowermost end of the housing. Such a temperature may reside in the range of for example about 95 degrees F. to 105 degrees F. so as to melt such confection but not so high as to harm a child or user of this apparatus.

The invention thus comprises a hand manipulable apparatus for the receipt and extrusion of a stream of edible material comprising an elongated housing having a first end and a second end, a discharge nozzle arranged in the first end, a chamber is arranged in the first end of the elongated housing for receipt of dry meltable edible material, a circuit is preferably arranged in the first end of the elongated housing for heating and melting the edible material, and a rotatable auger is arranged in the distal end of the housing for extruding the edible material out of the housing through the nozzle. The edible material is preferably comprised of a confectionary such as for example, chocolate. The circuit preferably includes an upper temperature limit controller. The auger is preferably of stepped diameter to permit control of extrusion of melted edible material. The auger preferably has a proximal portion of a first diameter and a distalmost tip of a second, reduced diameter than the first diameter. The distalmost tip of said auger preferably rotatively mates within the nozzle. An electric motor may be arranged in the second end of the housing. The electric motor may be in communication with a power cord extending from the elongated housing. The electric motor may alternatively be in communication with a battery in the second end of the housing.

The invention may also include a method of manipulably applying a fluid confectionary material to a surface, comprising one or more of the steps of: arranging a rotatable auger in a distal end of an elongated housing; depositing a dry confectionary material into the distal end of the elongated housing, about the auger; rotating the auger within the elongated housing; heating the distal end of the elongated housing to effect a temperature change in the confectionary material; and extruding a melt of confectionary material from a first nozzle arranged on the distal end of the elongated housing. The method may further include the steps of: moving the confectionary material through a stepped auger at the distal end of the elongated housing; attaching a proximal end of the auger to an electric motor in a proximal end of the elongated housing to permit the rotating of the auger; removing the nozzle from the distal end of the elongated housing; and replacing the nozzle with a second nozzle having a different configuration from the first nozzle. The distal end of the housing may be heated by an electric heating element arranged on or in the housing. The method may include: simultaneously activating the auger to rotate and the distal end of the housing to be heated by a switch arranged adjacent the distal end of the elongated housing.

### BRIEF DESCRIPTION OF THE DRAWINGS

The objects and advantages of the present invention will become more apparent when viewed in conjunction with the following drawings in which:

FIG. 1 is a perspective view of a confection writer apparatus constructed according to the principles of the present invention;

FIG. 2 is a perspective view of the writer apparatus shown in FIG. 1, in an exploded configuration;

FIG. 3 is a sectional view of the writer apparatus as shown in FIG. 1 in longitudinal section;

FIG. 4 is a perspective view of a further embodiment of the confection writer apparatus of the present invention; and

FIG. 5 is a perspective view of yet another embodiment of the confection writer apparatus of the present invention.

### DESCRIPTION OF THE PREFERRED EMBODIMENTS

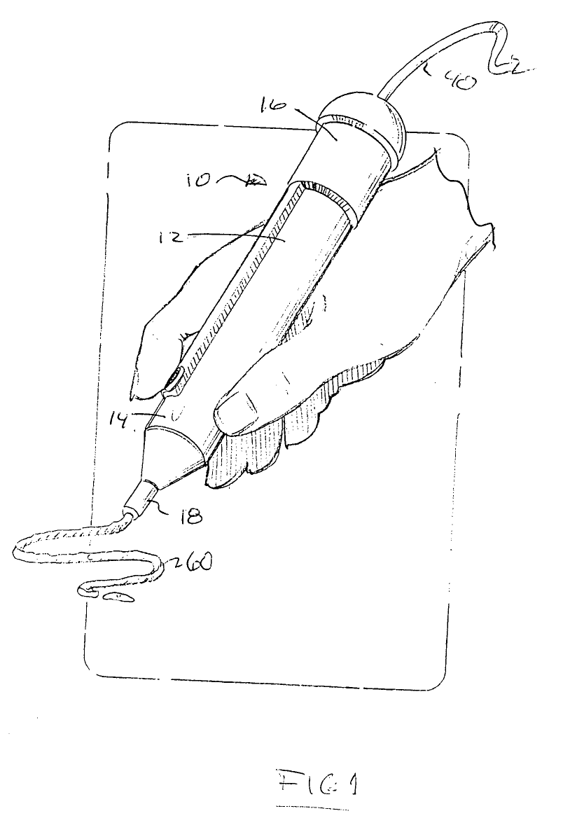

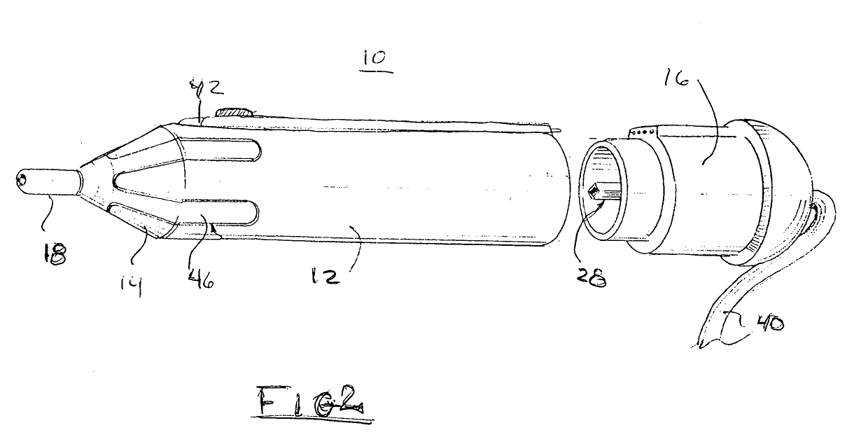

Referring now to the drawings in detail, and particularly to FIGS. 1 and 2, there is shown the present invention which comprises a small diameter (preferably about 1″ to 3″ for easy grasping use by children) confection applying device 10 comprises an elongated chamber or housing 12 of generally cylindrical configuration having a lower or first confection-extruding end 14 and an upper or second chamber-loading and power-adaptive end 16.

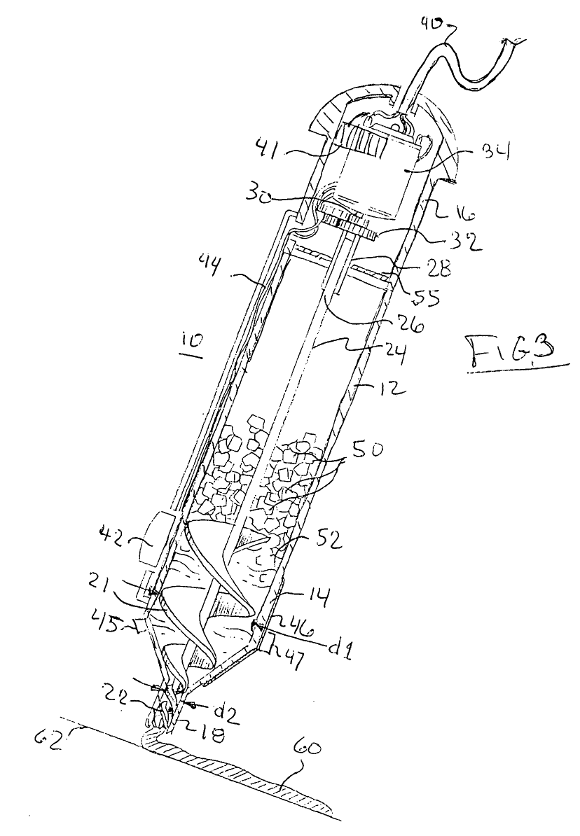

The lower or first end 14 has a replaceable fluid discharge nozzle 18 thereon. The elongated chamber comprises a housing 12 consists of a chamber into which a rotatable auger 20 is supported, as may be seen in FIG. 3. The auger 20 has a proximal portion 21 of a first diameter d1 and a tipped or distalmost end 22 tapering into a shaped, smaller, second diameter d2, which fits inside and is in supported, rotating communication within the nozzle 18 at the first or distalmost end 14 of the confection-applying device 10. The auger 20 is arranged about a rotatable shaft 24 having an upper or proximalmost end 26 which engages a coupler 28 supportively arranged within the proximal power-adaptive-end 16 of the housing 12.

The coupler 28, being arranged within the second or uppermost power-adaptive-end 16 of the confection-applying device 10, is attached to a drive shaft 30, as represented in FIG. 3. The drive shaft 30 is arranged on the upper or proximalmost end of a reducing gear transmission arrangement 32, supported within the proximal end 16 of the housing 12. The transmission arrangement 32 is attached to the output drive shaft 30 which is connected to an electric motor 34 arranged within the second or uppermost end 16 of the elongated housing 12, as shown in FIG. 3. A power cord 40, in one preferred embodiment of the present invention, may be arranged through the uppermost end of the housing 12 to a power supply, not shown.

A further aspect of the present invention comprises a battery unit 41, connected by proper means to the electric motor 34, as also represented in FIG. 3.

The upper power-adaptive-end 16 of the elongated housing 12 is separable from the main body portion of the chamber at the location where the shaft 24 meets the transmission coupler 28, as is represented in FIG. 2. The separability of the housing 12 into a relatively long portion permits the loading of a reasonably satisfactory amount, for example, about 1 to 8 ounces of dry “chips” or granules of a dry confectionary material without the mess associated with the prior art.

A control switch 42 is located adjacent to the distal or first end 14 of the elongated housing 12 for the convenience of manipulating the confection applying device 10 and turning the device 10 on or off. The control switch 42 may include a rheostat having an electric circuit 44 in communication with the electric motor 34 and power cable 40 or battery 41, to variably control the speed or direction of rotation of the output shaft 30 of the electric motor 34 and thereby control the speed or direction of rotation of the auger 20 on the auger shaft 24. The stepped down diameter of the auger 20 from d1 to d2 permits the use of a small diameter nozzle 18, permitting artistic expression of finer lines of a melted, extruded confectionary 60. The nozzle 18 may be replaceable with respect to the lower distal end 14 of the housing 12 by a screw thread arrangement 45, or the like, permitting a new nozzle 18 which is cleaner or of different cross-sectional shape or diameter to be placed thereon.

A temperature generating element 46 may be arranged within the wall of, around or adjacent a peripheral portion of the wall at the lower end 14 of the elongated housing 12, the temperature generating element 46, also controlled by the switch 42, the element 46 having an upper-temperature limitation arrangement 47 therewith, so as to minimize the amount of heat which may be provided to the lower housing 14 and the confectionary 50 therein.

The elongated housing 12 comprises an elongated chamber into which dry “chips” or powder of confectionary material 50 such as chocolate chips or other like chip or granular material may be disposed when the upper end 16 of the housing 12 is removed from that chamber portion thereof to permit a reasonably satisfactory supply of material for designing a confectionary artwork.

Thus a baker or cook or even a child may safely apply an edible confection of granular or fluid material 50 within the holding/melting chamber 52 of the elongated housing 12 when the upper end housing 16 is removed. The power-end housing 16, and thus and power cord 40 or battery 41 is thus safely away from the confectionary during loading of the chamber 52. A gasket 55 may be sealably disposed about the rotatable coupler 28 in the housing 16 to minimize any cross contamination of the motor 34 or the confectionary material 50. Actuation of the on/off control switch 42 may actuate the heating element 46 to provide a minimal temperature sufficient to melt the confectionary material 50 within the lowermost end 14 of the housing. Such a temperature may reside in the range of about 95 degrees F. to 105 degrees F. so as to melt such confection but not so high as to harm a child or user of this apparatus, and produce an applyable stream 60 of that melted edible material 55 to a substrate 62.

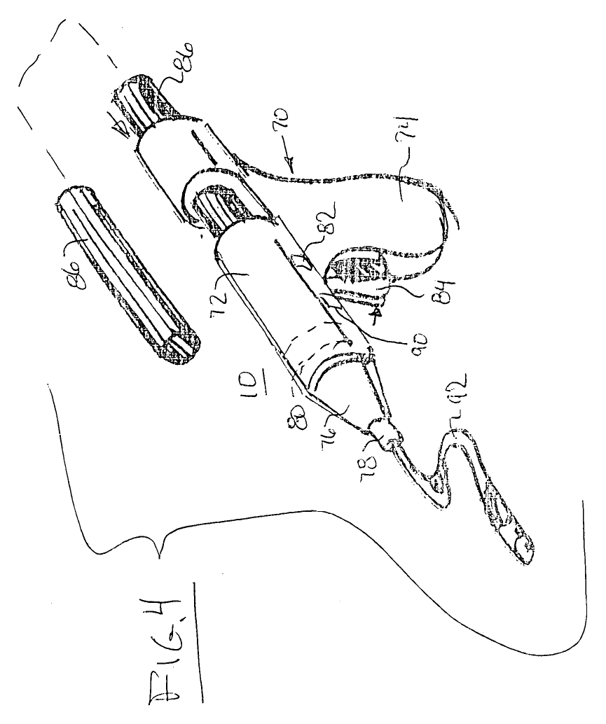

A further embodiment of the confection writer apparatus 10 of the present invention is shown in FIG. 4 showing a “pistol shaped” frame 70 having a forwardly directed barrel 72 and a handle 74. The barrel 72 has a distal end 76 with a tapered extrusion nozzle 78 arranged thereon. A heating element 80 is arranged within the barrel 72, A squeeze trigger 84 is pivotally connected to the frame 70 and extends adjacent the handle 74. Squeezing of the trigger 84, in one preferred embodiment activates the heater 80 by activation of a switch 82 in communication with the heater 80.

The barrel 72 is hollow, and is arranged to receive a solid bar of chocolate 86. The trigger 84, when pivotally squeezed, moves a ratchet pusher 90 to distally advance a bar of chocolate 86 forwardly through the barrel 72, into contact with the heated area of the apparatus 10, and hence to manipulably extrude a stream of melted chocolate 92 out of the nozzle 78, as represented in FIG. 4.

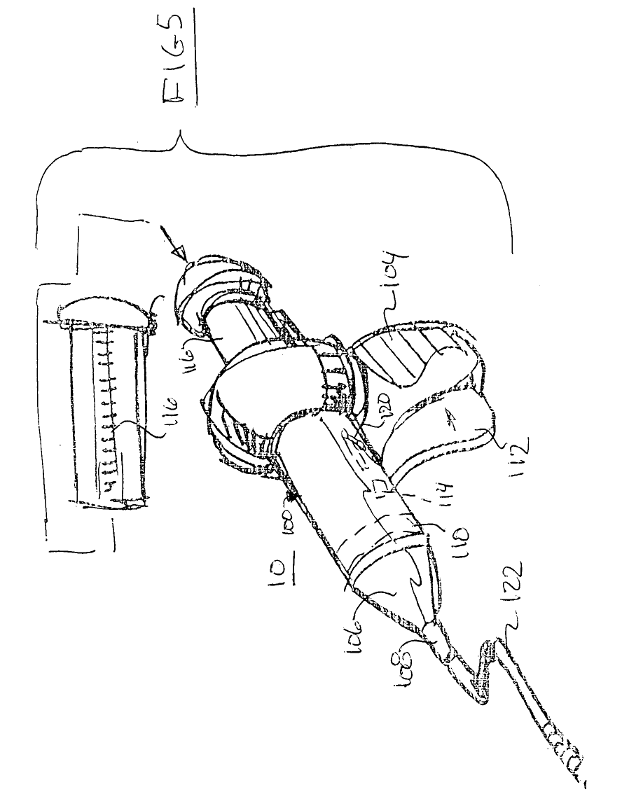

Another preferred embodiment of the present invention of the confectionary writer apparatus 10 is shown in FIG. 5 showing a “pistol shaped” frame 100 having a forwardly directed barrel 102 and a handle 104 extending off of the barrel 102. The barrel 102 has a distal end 106 with a tapered extrusion nozzle 108 arranged thereon. A heating element 110 is arranged within the barrel 102. A squeeze trigger 112 is pivotally connected to the frame 100 and extends adjacent the handle 104. Squeezing of the trigger 112 in one preferred embodiment activates the heater 110 by activation of a switch 114 in communication with the heater 110.

The barrel 102 is hollow, and is arranged to preferably receive a granular or chipped or solid bar of chocolate 116. A second chamber 118 enclosed the chocolate 116. The chamber 118 is telescopingly arranged to slide into the barrel 102 when the trigger 112 is pivotally squeezed, the trigger squeeze movement also moves a ratchet pusher 120 to distally advance the second chamber 118 and hence push the chocolate 116 loaded in the chamber 118 forwardly through the barrel 102 and extrude a stream of melted chocolate 122 out of the nozzle 108, as represented in FIG. 5.

I claim:

1. A hand manipulable apparatus for the receipt and extrusion of a stream of edible material comprising:
an elongated housing having a first end and a second end;
a discharge nozzle in said first end;
a chamber in said first end of said elongated housing for receipt of dry meltable edible material;
a circuit arranged in said first end of said elongated housing for heating and melting said edible material; and
an edible material advancing member for extruding said edible material out of said housing through said nozzle.

2. The apparatus as recited in claim 1, wherein said edible advancing member is a rotatable auger.

3. The apparatus as recited in claim 1, wherein said edible material is comprised of chocolate.

4. The apparatus as recited in claim 1, wherein said circuit includes an upper temperature limit controller.

5. The apparatus as recited in claim 1, wherein said auger is of stepped diameter to permit control of extrusion of melted edible material.

6. The apparatus as recited in claim 5, wherein said auger has a proximal portion of a first diameter and said auger has a distalmost tip of a second, reduced diameter than said first diameter.

7. The apparatus as recited in claim 6, wherein said distalmost tip of said auger rotatively mates within said nozzle.

8. The apparatus as recited in claim 1, having an electric motor in said second end of said housing.

9. The apparatus as recited in claim 8, wherein said electric motor is in communication with a power cord extending from said elongated housing.

10. The apparatus as recited in claim 8, wherein said electric motor is in communication with a battery in said second end of said housing.

11. The apparatus as recited in claim 2, wherein said chocolate advancing member is a chocolate bar engaging ratchet.

12. The apparatus as recited in claim 2, wherein said chocolate advancing member is a second solid-chocolate enclosing chamber for advancing unmelted chocolate towards a nozzle.

13. A method of manipulably applying a fluid confectionary material to a surface, comprising the steps of:
arranging a rotatable auger in a distal end of an elongated housing;
depositing a dry confectionary material into said distal end of said elongated housing, about said auger;
rotating said auger within said elongated housing;
heating said distal end of said elongated housing to effect a temperature change in said confectionary material; and
extruding a melt of confectionary material from a first nozzle arranged on said distal end of said elongated housing.

14. The method as recited in claim 13, including:
moving said confectionary material through a stepped auger at said distal end of said elongated housing.

15. The method as recited in claim 13, including:
attaching a proximal end of said auger to an electric motor in a proximal end of said elongated housing to permit the rotating of said auger.

16. The method as recited in claim 13, including:
removing said nozzle from said distal end of said elongated housing; and
replacing said nozzle with a second nozzle having a different configuration from said first nozzle.

17. The method as recited in claim 13, wherein said distal end of said housing is heated by an electric heating element arranged on said housing.

18. The method as recited in claim 13, including:
activating said auger to rotate and said distal end of said housing to be heated by a switch arranged adjacent said distal end of said elongated housing.
